(19) United States
(12) Patent Application Publication
(10) Pub. No.: US 2020/0144858 A1
(43) Pub. Date: May 7, 2020

(54) Electronic Device Protective Case for Wireless

(71) Applicant: Shen Zhen Shi Aiker Electronic Technology co., LTD., Shenzhen (CN)

(72) Inventor: Yao Su, Wanyuan (CN)

(21) Appl. No.: 16/735,728

(22) Filed: Jan. 7, 2020

(30) Foreign Application Priority Data
Nov. 11, 2019 (CN) 201921934850.3

(51) Int. Cl. H02J 50/00; H02J 50/10

(52) U.S. Cl. CPC H02J 50/005; H02J 50/10

(57) ABSTRACT

An electronic device protective case for wireless charging comprises a shell used for clamping an electronic device. A magnetism-isolation sheet is laid on the inner bottom surface of the shell, A hollowed-out part matched with a wireless charging coil is formed in the magnetism-isolation sheet. A mismatched electromagnetic field is shielded by means of the magnetism-isolation sheet to avoid an influence on metal in the electronic device, so that the situation that the metal becomes hot under the effect of the magnetic field is avoided, damage to components and welding spots on a circuit board is also avoided, and thus, metal parts in the mobile phone or the tablet computer will not be affected no matter whether or not the protective case matches the mobile phone or the tablet computer in position; and meanwhile, diffusion of the electromagnetic field is reduced, and charging efficiency is effectively improved.

### BACKGROUND OF THE INVENTION

### Technical Field

The utility model relates to technical field of protective cases, in particular to an electronic device protective case for wireless charging.

### Description of Related Art

With the rapid development of scientific and technical levels, the functions of electronic devices such as mobile, phones and tablet computers are becoming more and more powerful. Particularly, the functions of the mobile phones have expanded to all fields of life and work from the simplex communication function, which makes the mobile phones become indispensable articles for daily life. With the increase and diversification of the brands and functions of the mobile phones or tablet computers, protective cases are classified by texture into leather cases, silica gel cases, cloth cases, hard plastic cases, fur cases, metal cases, soft plastic cases, woolen cases, silk cases, and the like. Mobile phone protective cases not only can be used as decorations to make mobile phones more attractive, but also can protect the mobile phones against falling, scratching and shaking.

At present, the mobile phones or tablet computers are generally charged in two manners, namely conventional wired charging and wireless charging, wherein wireless charging is implemented by means of a charging coil which generates a corresponding magnetic field to realize power transmission, while metal may become hot and the endurance strength of the metal may be affected if the metal stays in such magnetic field for a long time. Because various metal parts are configured in the mobile phones, if a coil on a charging base is staggered with a coil of mobile phones with a wireless charging function due to a positional mismatch, other parts, rather than the coil, of the mobile phones will be in butt joint with the coil on the charging base which will cause potential safety hazards a long time later.

### BRIEF SUMMARY OF THE INVENTION

The objective of the utility model is to overcome the defects of the prior art by providing an electronic device protective case for wireless charging.

The technical solution adopted by the utility model to fulfill the above objective is as follows:

An electronic device protective case for wireless charging comprises a shell used for clamping an electronic device, wherein a magnetism-isolation sheet is laid on the inner bottom surface of the shell, and a hollowed-out part matched with a wireless charging coil is formed in the magnetism-isolation sheet.

By adoption of the above solution, the electronic device protective case of the utility model is disposed outside an electronic device, such as a mobile phone or a tablet computer, by means of the shell, the magnetism-isolation sheet is laid on the shell, and the hollowed-out is formed in a position, corresponding to a charging coil in the mobile phone or the table computer, of the magnetism-isolation sheet to prevent a charging magnetic field from being shielded; a mismatched electromagnetic field is shielded by means of the magnetism-isolation sheet to avoid an influence on metal in the electronic device, so that the situation that the metal becomes hot under the effect of the magnetic field is avoided, damage to components and welding spots on a circuit board is also avoided, and thus, metal parts in the mobile phone or the tablet computer will not be affected no matter whether or not the protective case matches the mobile phone or the tablet computer in position; and meanwhile, diffusion of the electromagnetic field is reduced, and charging efficiency is effectively improved.

### BRIEF DESCRIPTION OF THE SEVERAL VIEWS OF THE DRAWINGS

FIG. 1 is a structural schematic diagram of one embodiment of the utility model.

FIG. 2 is a sectional view of the embodiment of the utility model.

FIG. 3 is a structural diagram of the embodiment of the utility model applied to a tablet computer.

### DETAILED DESCRIPTION OF THE INVENTION

The embodiments of the utility model are detailed below in combination with the accompanying drawings, while the utility model can be implemented in various manners as defined and covered by the claims.

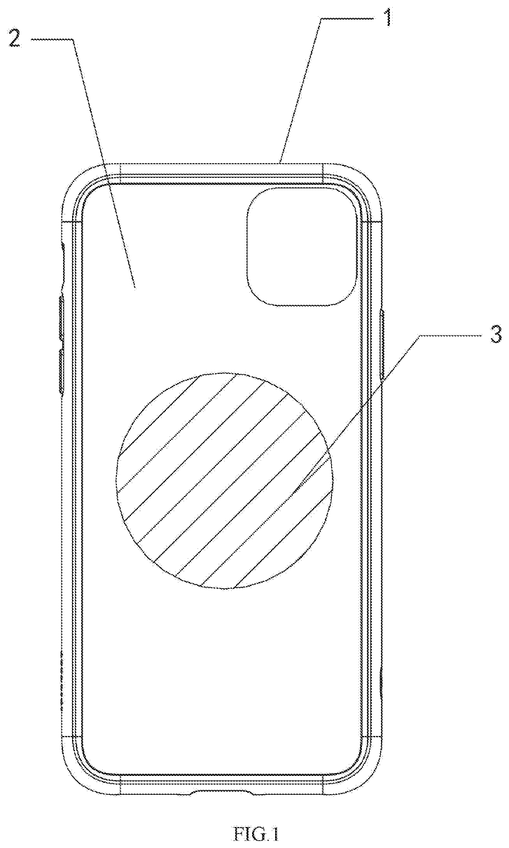

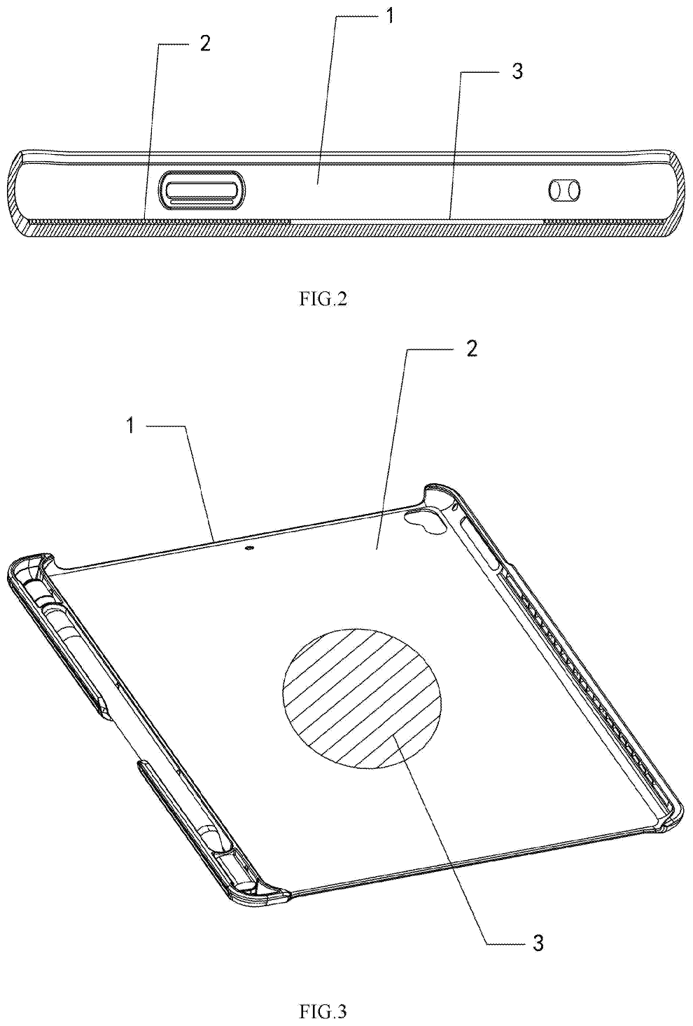

As shown in FIG. 1 to FIG. 3, this embodiment provides an electronic device protective shell for wireless charging. The electronic device protective shell for wireless charging comprises a shell 1 used for clamping an electronic device, wherein a magnetism-isolation sheet 2 is laid on the inner bottom surface of the shell 1, and a hollowed-out part 3 matched with a wireless charging coil is formed in the magnetism-isolation sheet 2.

Furthermore, the magnetism-isolation sheet 2 is made from ferrite, nanocrystalline, or other materials.

The electronic device protective case in this embodiment is particularly suitable for mobile phones or tablet computers and is typically applied to mobile phone protective cases. Particularly, when used, the electronic device protective case is disposed outside a mobile phone or a tablet computer by means of the shell, the magnetism-isolation sheet 2 is laid on the shell, and the hollowed-out part 3 is formed in a position, corresponding to a charging coil in the mobile phone or the tablet computer, of the magnetism-isolation sheet 2, so that a charging magnetic field is prevented from being shielded; a mismatched electromagnetic field is shielded by means of the magnetism-isolation sheet 3 to avoid an influence on metal in the electronic device, so that the situation that the metal becomes hot under the effect of the magnetic field is avoided, damage to components and welding spots on a circuit board is also avoided, and thus, metal parts in the mobile phone or the tablet computer will not be affected no matter whether or not the protective case matches the mobile phone or the tablet computer in position; and meanwhile, diffusion of the electromagnetic field is reduced, and charging efficiency is effectively improved.

The above embodiments are only preferred ones of the utility model, and are not intended to limit the patent scope of the utility model. All equivalent structures or equivalent process transformations made according to the contents of the specification and the accompanying drawings of the utility model, or direct or indirect applications to other related technical fields shall also fall within the patent protection scope of the utility model.

1. An electronic device protective case for wireless charging, comprising a shell used for clamping an electronic device, wherein a magnetism-isolation sheet is laid on an inner bottom surface of the shell, and a hollowed-out part matched with a wireless charging coil is formed in the magnetism-isolation sheet.
